(19) United States
(12) Patent Application Publication
(10) Pub. No.: US 2008/0002729 A1
(43) Pub. Date: Jan. 3, 2008

(54) Local add traffic exchange between separate East/West line cards in a half-MAC architecture for the resilient packet ring

(75) Inventor: Marcus Duelk, Fair Haven, NJ (US)

Correspondence Address: WERNER & AXENFELD, LLP, P.O. BOX 1629, WEST CHESTER, PA, 19380, US

(73) Assignee: Lucent Technologies, Inc.

(21) Appl. No.: 11/477,754

(22) Filed: Jun. 29, 2006

(51) Int. Cl. H04L 12/28

(52) U.S. Cl. 370/404

(57) ABSTRACT

Local add traffic exchange between separate East and West line cards in a Half-MAC architecture for Resilient Packet Ring networks is provided by a scheduler and a shared transit path between RPR MACs. By sharing the interconnecting bus that is used for the transit of traffic between the two RPR MACs, a path is provided for the local add traffic that needs to be redirected to the other RPR line card.

### FIELD OF THE INVENTION

The present invention relates generally to communication networks, and more particularly relates to local add traffic exchange between separate East/West line cards in a Half-MAC architecture for a Resilient Packet Ring network architecture.

### BACKGROUND

In recent times there have been dramatic increases in the demand for communication services such as the transmission of all types of data. Concurrently, advances in several areas, including but not limited to, digital systems architecture, semiconductor manufacturing processes, and optical communication devices, have provided engineers and designers with the resources to implement a number of very high performance networks in order to meet the aforementioned demand for communication services.

A number of communication network architectures and protocols have been developed to specifically provide for various communications needs. One such network that has recently been specified by the Institute of Electrical and Electronic Engineers (IEEE) is a new ring topology network known as the Resilient Packet Ring (RPR), and the specification itself is referred to as IEEE 802.17. Networks in accordance with the Resilient Packet Ring specification provide a means for transporting data traffic over logical rings. These rings are commonly implemented, physically, as fiber rings, that is, light wave communication signals are transported through optical fibers. RPR is suitable for use in access, metropolitan and wide area networks.

It is noted that RPR can be realized both over an existing TDM (i.e., SONET or SDH or Optical Transport Network, OTN ITU-T G.872/G.709) network infrastructure or in a packet transport network. In other words, both TDM PHYs and Packet PHYs are supported by the IEEE 802.17 RPR standard. For a packet infrastructure, RPR offers benefits similar to the prominent IEEE 802.3 Ethernet technology, for example in terms of statistical multiplexing or auto-configuration. However, native Ethernet can not be employed over existing ring networks because it requires a loop-free topology which is why RPR is an attractive packet transport technology. Further, RPR offers fairness and carrier-grade resilience typically found in SONET/SDH networks. As mentioned above, RPR can be also employed as a service over an existing TDM transport infrastructure. In general, different network, system and line card architectures exist to implement RPR.

RPR networks are dual ring topologies with information traveling in opposite directions on the two rings. This is referred to as dual counter-rotating rings, and each of the rings may be referred to as a ringlet. RPR stations at the various nodes of an RPR network include Media Access Controllers. This type of ring network provides many features for reliable data communication. For example, “steering” and “wrapping”, are capabilities that provide for handling traffic when a node fails or a span is broken.

Traffic on RPR networks is assigned a particular class of service (i.e., A, B, or C). Class A is for real-time traffic such as voice or video, for which it is helpful to have low latency and low jitter. Class B has a lower priority than class A, but still offers bounded jitter and latency, while class C has the lowest priority and is used for best-effort traffic.

Line cards for the Resilient Packet Ring (IEEE 802.17-2004) have an East and a West interface. These interfaces can be physically located either on one line card or on separate line cards. The separate line card architecture is preferred for carrier-grade equipment because the redundant card is required for equipment protection purposes. The RPR Media Access Controller (MAC) operates to control the ring access, that is, adding local traffic from the clients onto the ring; managing transit traffic (forwarding from East to West interface and vice versa); and dropping traffic off the ring and forwarding it to local clients. The RPR MAC may be thought of as a packet add/drop multiplexer. Packets added by the local node are inserted onto the ring; packets received by the local node are dropped from the ring; and packets received from an upstream node, which are to be forwarded to a downstream node, transit through the station and are transmitted back onto the ring. Various control algorithms, e.g., a fairness algorithm, control access to the ring from each node.

Two different RPR architectures exist with separate East/West cards which are referred to as either Master-and-Slave or Half-MAC architecture. In the Master-and-Slave architecture two identical East/West cards are used where only one of them, the master line card, is active and operating as one logical entity, i.e., as one RPR station on the ring. The slave line card only offers the physical trunk port to the network but is otherwise not involved in the packet processing or in the reception of traffic from the local clients, i.e., the slave line card is in stand-by and pass-through mode and will become the master under protection in case the master line card fails or is unplugged. This means that in the Master-and-Slave RPR architecture only the master line card receives traffic from the clients. In the Half-MAC RPR architecture, again two identical East/West cards are used but contrary to Master-and-Slave architecture both of them are processing transit and local add/drop traffic. This means that in the Half-MAC RPR architecture both East and West line cards receive data from the clients. This also means that the throughput from the ring to the clients (local drop) and from the clients to the ring (local add) is twice as high in the Half-MAC architecture as it is in the Master-and-Slave architecture. It will be appreciated that for this reason the Half-MAC architecture is the preferred RPR carrier-grade architecture with separate East and West cards. However, an additional technical complexity of the Half-MAC architecture is the required capability to exchange local add traffic between the East and West cards. This might be required for various reasons, for example local add traffic arriving from the clients on either of the East or West cards but needing to be launched onto the ring from the opposite card because of changing topologies or protection mechanisms, or under bidirectional flooding, which is a broadcast mechanism in both directions around the ring and hence on both the East and West interface, or because of other reasons that might occur during regular operation. A straight-forward approach for exchanging local add traffic between separate East/West cards is to create an interconnection between, or before, the RPR traffic managers (RPR TMs). Unfortunately, such an approach results in technical complexity with respect to the backplane and the interconnect, additional costs, and additional I/O ports resulting in elevated power consumption.

What is needed are methods and apparatus for exchanging local add traffic between separate East/West cards with lower costs and fewer complexities.

### SUMMARY OF THE INVENTION

Briefly, local add traffic exchange between separate East/West line cards in a Half-MAC architecture for Resilient Packet Ring networks is provided by a scheduler, a shared transit path between RPR MACs and intelligent memory management. By sharing the interconnecting bus that is used for the transit of traffic between the two RPR MACs, a path is provided for the local add traffic that needs to be redirected to the other RPR line card.

### BRIEF DESCRIPTION OF THE DRAWINGS

FIG. 1 is an illustrative high-level schematic block diagram of a Resilient Packet Ring showing several stations and the dual counter-rotating rings which are part of the RPR network architecture.

FIG. 2 is a high-level schematic block diagram representing a portion of a station used in a RPR network illustrating the paths for incoming traffic entering the station, local drop traffic that is taken off the ring by this station, local add traffic that is put onto the ring by this station, and a pair of transit queues for traffic that is passing through this station. RPR stations can be realized either with single or dual transit queue, the latter option being shown here as an example.

FIG. 3 depicts four examples of RPR system architectures, including arrangements in which both client and trunk PHYs are on the same RPR card, and arrangements in which both client and ring traffic is aggregated via a packet fabric or a TDM fabric, respectively.

FIG. 4 is a schematic block diagram of an illustrative RPR system architecture with a pair of separate RPR (East/West) line cards, each card having a fabric interface, a traffic manager, a network processor, a Reroute-and-Receive block, a RPR traffic manager, a RPR Half-MAC, and a PHY.

FIG. 5 is a schematic block diagram of an illustrative RPR system architecture with a pair of separate RPR (East/West) line cards in accordance with the present invention, each card having a fabric interface, a traffic manager, a network processor, a RPR traffic manager, a RPR Half-MAC, and a PHY.

FIG. 6 is a schematic block diagram of portions of a pair of RPR (East/West) line cards, showing the data paths for exchanging add traffic between the Half-MACs of each RPR line card.

FIG. 7 is a flow diagram of a method of process in accordance with the present invention.

### DETAILED DESCRIPTION

Various embodiments of the present invention relate to exchanging local add traffic between the Resilient Packet Ring Media Access Controllers of a pair of separate East/West RPR line cards, by using the transit path. In other words, the transit path is shared between, i.e., used by both, the transit traffic and the local add traffic. This is achieved by an enhanced scheduler in the RPR MACs in conjunction with intelligent memory management. This is different from approaches in which exchange of local add traffic is realized by additional and separate paths between, or before, the RPR TMs of each card.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

### Terminology

The acronym ASIC refers to an Application Specific Integrated Circuit. ASICs are integrated circuits that are designed to include functionality that is specifically tailored for a particular application. ASICs may be fabricated in any suitable semiconductor technology.

The acronym FPGA refers to a Field Programmable Gate Array. FPGAs are integrated circuits that may be configured, i.e., programmed, so that the circuit elements therein are interconnected in a manner that produces a specifically tailored function. FPGAs may be fabricated in any suitable semiconductor technology.

The acronym DRAM refers to dynamic random access memory, and the acronym SRAM refers to static random access memory.

The terms chip, integrated circuit, semiconductor device, and microelectronic device are sometimes used interchangeably in this field. Various embodiments of the present invention may be implemented in one or more integrated circuits, and so the present invention relates to all of the foregoing as these terms are commonly understood in the field.

It is desirable to have an IEEE 802.17 Resilient Packet Ring network and line card architecture with separate East and West line cards to provide for equipment protection by way of redundant circuit packs. Furthermore, it is desirable to have both East and West RPR line cards active in operation in a so-called Half-MAC configuration in order to maximize the the traffic throughput to and from the clients.

Traffic from the clients, referred to as local add traffic, arriving at the EastNVest card from either the client ports or through a packet switch fabric (or more simply “packet fabric”) from client cards may need to be redirected to the opposite RPR card. Such redirection may be required for reasons such as, but not necessarily limited to, bidirectional flooding on the ring, switching under protection, or other reasons that may cause a packet to be launched onto the ring from the East (West) interface but arriving on the West (East) card from the packet fabric or the client ports.

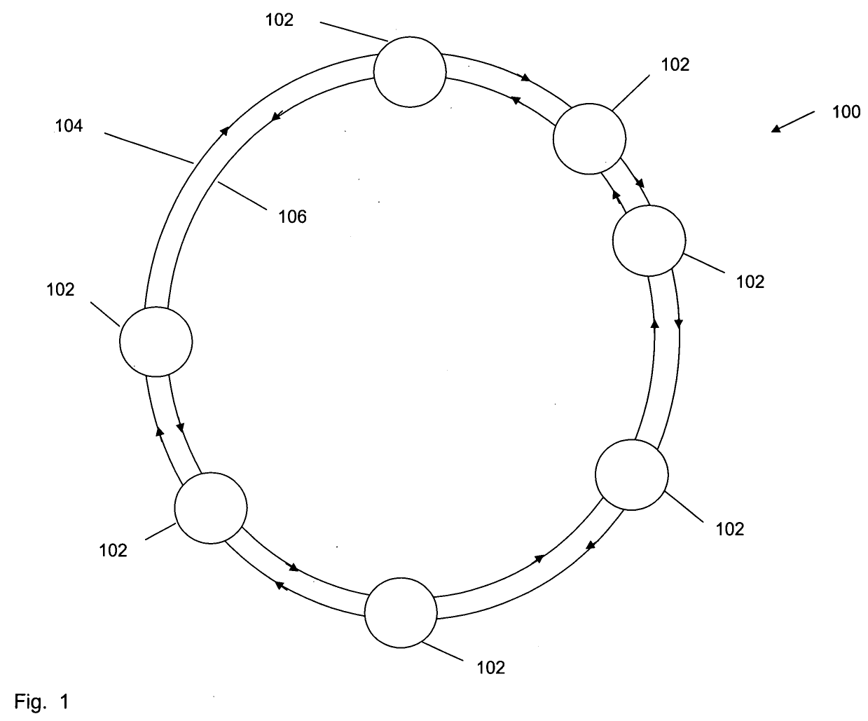

Referring to FIG. 1, an illustrative high-level representation of a Resilient Pact Ring network 100 is shown. A number of nodes 102 having RPR stations therein are shown coupled to both a first ring 104 and a second ring 106. It can be seen from the arrowheads on the rings of FIG. 1, that traffic on counter-rotating rings 104, 106 is moving in opposite directions. The first ring 104 may be referred to as the outer ring, or ringlet 0, and data travels clockwise on first ring 104. The second ring 106 may be referred to as the inner ring, or ringlet 1, and data travels counter-clockwise on second ring 106.

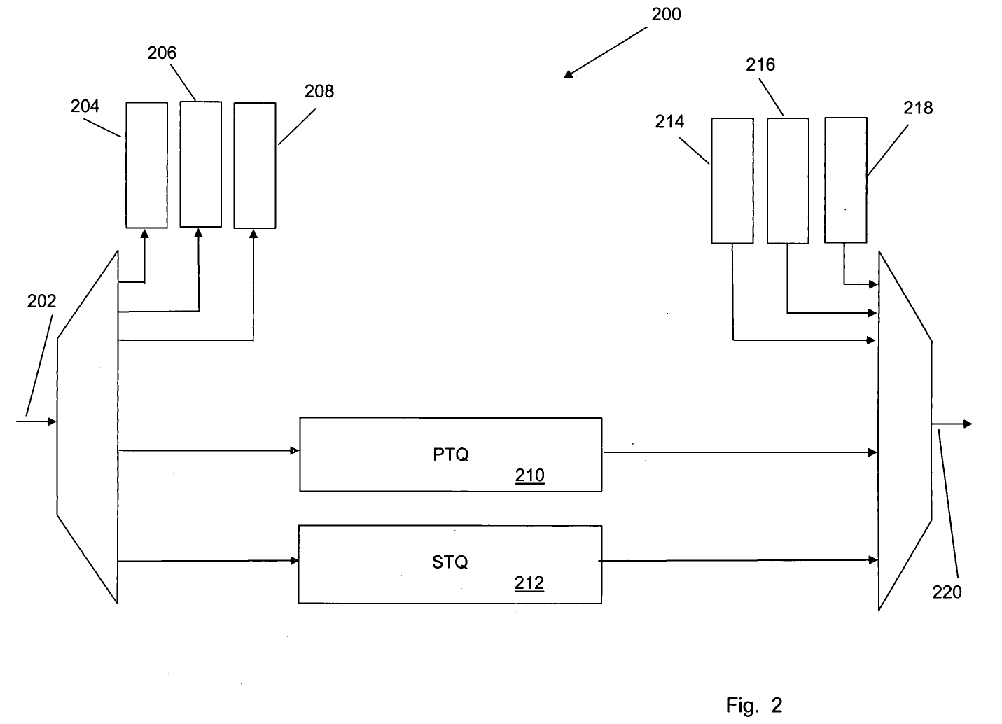

FIG. 2 shows an illustrative high-level schematic block diagram of a portion of a station 200 used in a Resilient Packet Ring network. Incoming traffic 202 enters station 200 from the ring. It will be appreciated that the illustrated portion of station 200 of FIG. 2 is for purposes of explanation, and is shown as connecting to only one ringlet of the counter-rotating pair that is found in RPR networks in accordance with IEEE 802.17. Incoming traffic may be directed to the local clients or may pass through, i.e., transit, station 200. If incoming data 202 from the ring is to be delivered to a local client it is dropped from the ring (i.e., it is not re-transmitted back onto the ring), and, in the example of FIG. 2, data 202 is queued in accordance with its class. For example, data classified as class A may be transferred to queue 204, data classified as class B may be transferred to queue 206, and data classified as class C may be transferred to queue 208. These queues could be found at the ingress traffic manager in front of a packet switch fabric before the local drop traffic is forwarded through the switch fabric to the individual client ports. Alternatively, queues 204, 206, 208 may simply be the appropriate client destination. In any case, elements 204, 206, 208 may be viewed as data sinks. If incoming data 202 is to pass through, or transit, station 200, it is typically buffered in a storage area such as the Primary Transit Queue (PTQ) 210 or the Secondary Transit Queue (STQ) 212, prior to being transmitted back onto the ring. The implementation of an STQ is optional within the IEEE 802.17 specification, i.e., the storage area for the transit traffic may consist only of one buffer representing the PTQ. FIG. 2 further shows data sources, or queues or buffers, 214, 216, 218 coupled to a multiplexer that produces as an output of the desired data 220 for transmission onto the ring. In other words, local add traffic may originate from any of the queues 214, 216, 218. Queues 214, 216, 218, may store data in accordance with the class associated with that data. These queues could be found at the ingress traffic manager in front of a switch fabric before the local add traffic is forwarded through the packet fabric to the East or West RPR card. Alternatively, these queues could be found on the East or West RPR card at the egress TM or at the RPR TM, respectively. It will be appreciated that the present invention is not limited to any particular arrangement of buffers, queues, or data storage areas.

One approach to exchange local add traffic between East/West line cards is to provide additional transmission lines between the RPR traffic managers. This approach, in which local add traffic between the RPR line cards is exchanged via separate high-speed lines, results in the introduction of technical complexity such as an increased number of backplane lines (and associated higher costs), backplane design complexity, additional I/O ports in the RPR TM (or other ASICs or FPGAs) and hence elevated power consumption, buffering, the need to implement an intelligent receive end that resembles a switch fabric with the capability of traffic policing and traffic classification, traffic shaping, discarding mechanisms, additional packet buffering capabilities, flow control and backpressure mechanisms to the transmitting end on the other RPR line card, and so forth. The interconnecting lines for the local add traffic can also be implemented in a separate block (referred to herein as “Reroute-and-Receive”) which might add additional hardware, costs, power consumption, board space, and so on.

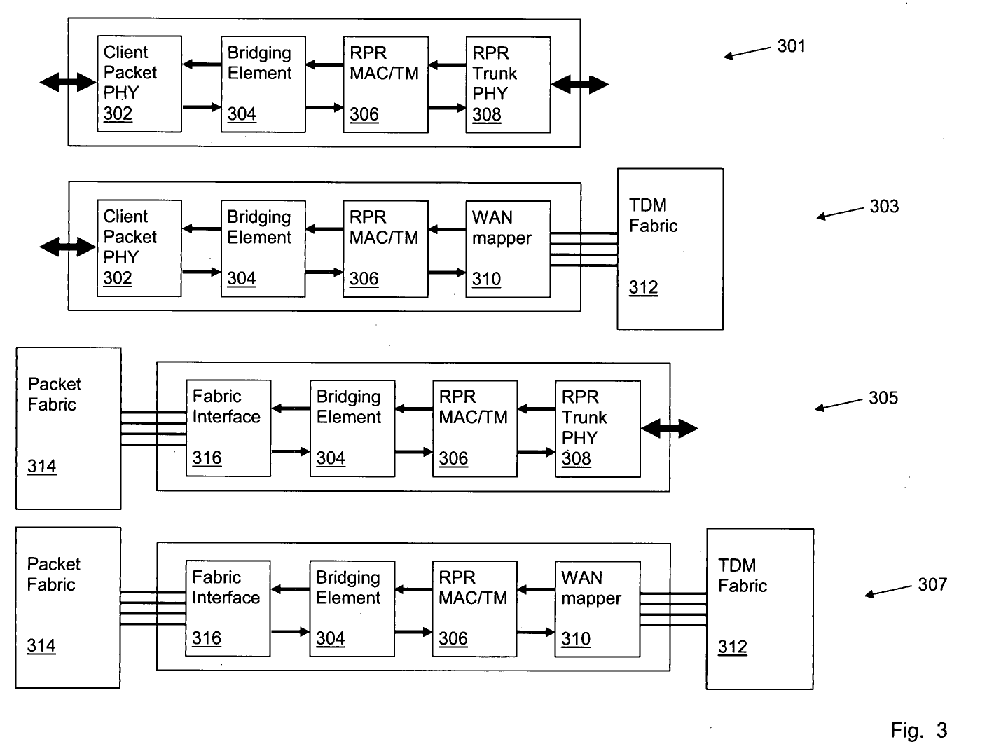

FIG. 3 shows four illustrative examples 301, 303, 305, 307 of how RPR can be architecturally realized on line cards. It will be appreciated that the present invention offers benefits for any RPR system or line card architecture that employs separate East/West cards. For example, RPR line cards could be realized similar to 301 where a client packet PHY 302 is connected to a bridging entity 304, which performs relay from the client protocol to the RPR protocol, to an RPR MAC and TM 306, and an RPR trunk PHY 308, which physically connects to the ring. RPR trunk PHY 308 could be either a packet PHY or a TDM PHY. Alternatively, instead of having RPR trunk PHYs 308 directly on the East/West RPR line cards, the RPR MAC/TM 306 device can connect to a WAN mapper 310 which maps the RPR packets onto a SONET/SDH circuit via Generic Framing Procedure and Virtual Concatenation (GFP and VCAT, ITU-T G.7041) before they are switched over a TDM switch fabric 312 to TDM trunk cards, which would physically connect to the ring network. Exemplary line card 303 is suitable when RPR is added as a packet transport technology over an existing TDM transport network where trunk aggregation across multiple TDM line cards can be realized. Similarly, RPR line card architectures 305, 307 can be realized where the client packet PHYs 302 are removed from the RPR East/West card and replaced by a fabric interface adapter 316 which allows for traffic aggregation across multiple client cards across a packet switch fabric 314. In the following we will limit our discussion of the present invention to the particulars of RPR line card architecture 305. However, as mentioned above, the present invention can be applied to any architecture that employs separate East/West RPR line cards in a Half-MAC configuration.

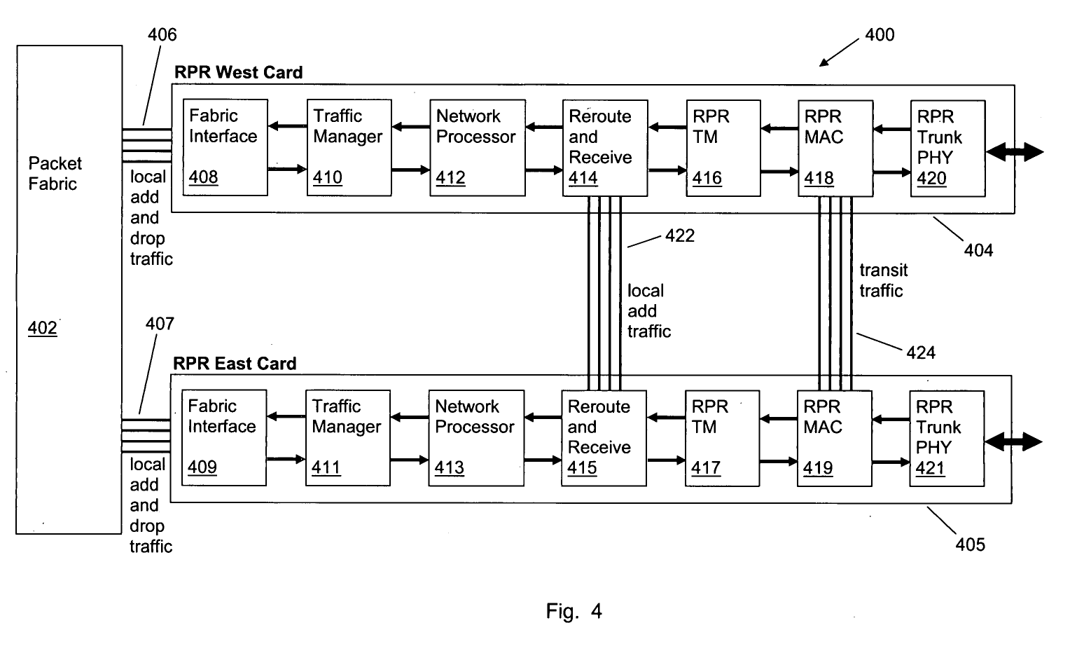

FIG. 4 is a high level block diagram of an RPR station 400 illustrating the approach in which local add traffic between a West line card 404 and an East line card 405 is exchanged via separate high-speed lines 422. More particularly, West line card 404 and East line card 405 are coupled to a packet fabric 402. West line card 404 includes a fabric interface chip 408 coupled to a Traffic Manager (TM) 410; a Network Processor (NP) 412 coupled to TM 410; a Reroute-and-Receive block 414 coupled to NP 412; an RPR TM block 416 coupled to Reroute-and-Receive block 414; an RPR MAC 418 coupled to RPR TM block 416; and an RPR trunk PHY 420 coupled to RPR MAC 418. Similarly, East line card 405 includes a fabric interface chip 409 coupled to a TM 411; an NP 413 coupled to TM 411; a Reroute-and-Receive block 415 coupled to NP 413; an RPR TM block 417 coupled to Reroute-and-Receive block 415; an RPR MAC 419 coupled to RPR TM block 417; and an RPR trunk PHY 421 coupled to RPR MAC 419. The local add traffic in this line card architecture is transmitted from client cards through packet fabric 402 over high-speed backplane lines 406 to RPR West card 404 or over backplane lines 407 to RPR East card 405. In this example, the local add traffic is queued by RPR TMs 416 and 417, respectively, before being added onto the ring by RPR Half-MACs 418 and 419, respectively. Some of the local add traffic may be sent to the other RPR line card via dedicated backplane lines 422 that originate and terminate at the Reroute-and-Receive blocks 414 and 415, respectively. Reroute-and-Receive blocks 414 and 415 may be integrated into RPR TMs 416 and 417, respectively, which again could be integrated with RPR MACs 418 and 419, respectively. RPR Half-MACs 418 and 419 also feature a high-speed backplane interconnect 424 for the transit traffic or the RPR ring. In the opposite direction, traffic that is received from the ring by the RPR trunk PHYs 420 and 421 and classified by the RPR MACs 418 and 419 as local drop traffic for the clients will bypass the RPR TMs 416 and 417 as well as the Reroute-and-Receive blocks 414 and 415 and reach the NPs 412 and 413 for further packet processing, including queue selection for the ingress TMs 410 and 411 where the traffic is queued before being forwarded via high-speed backplanes lines 406 and 407 over the packet fabric 402 to the clients.

Still referring to FIG. 4, the logical block “Reroute-and-Receive” acts to redirect packets from the local add traffic to the other line card if the Network Processor, or any other bridging element, classifies the incoming packet from the packet fabric as being destined for the other RPR line card. This has the advantage that the RPR TM, which is responsible for queuing the local add traffic (class-based or destination-based queuing), on each line card is queuing packets that will leave the card through the PHY of that same line card. This reduces scheduling complexity in the RPR MAC. Unfortunately, this has the drawback of introducing complexity in the Reroute-and-Receive block at the receiving end. More particularly, two streams of equal peak rate are arriving at this block, one from the network processor (from the packet fabric) and one from the opposite RPR line card, that need to be merged into one stream either before or inside the RPR traffic manager block. As a result, this Reroute-and-Receive block has to perform buffering, packet classification, policing, shaping, eventually discarding packets, and so on. The required functionality resembles that of a switch with a 2:1 oversubscription. It is noted that a backpressure mechanism, and flow control, may need to be implemented between these two Reroute-and-Receive blocks. The foregoing disadvantages manifest themselves as additional complexity in the implementation of such a product. Further, this approach requires additional transmit/receive channels between the RPR line cards (via the backplane) that will add to the power consumption and the complexity of the backplane and line card design.

However, various approaches in accordance with the present invention require only an additional degree of scheduling in the RPR MACs and additional queues in the memories, but otherwise offer benefits by omitting all the additional technical complexity described above. The scheduler in each MAC regulates access onto the ring for each particular physical interface (PHY). For example, the East (West) MAC not only would have to schedule the transit traffic arriving from the West (East) card and exiting on the East (West) card plus the local add traffic from the East (West) RPR card, but in the architecture in accordance with the present invention, the MAC would also schedule the access of the local add traffic from the East (West) onto the transit lanes towards the opposite West (East) card. This enhanced scheduling capability of the MAC, in some embodiments of the present invention, might also support additional RPR features such as Virtual Destination Queuing (VDQ). In other words, slightly elevated complexity in scheduling is compensated for by significant benefits resulting from the simplified exchange mechanisms for local add traffic.

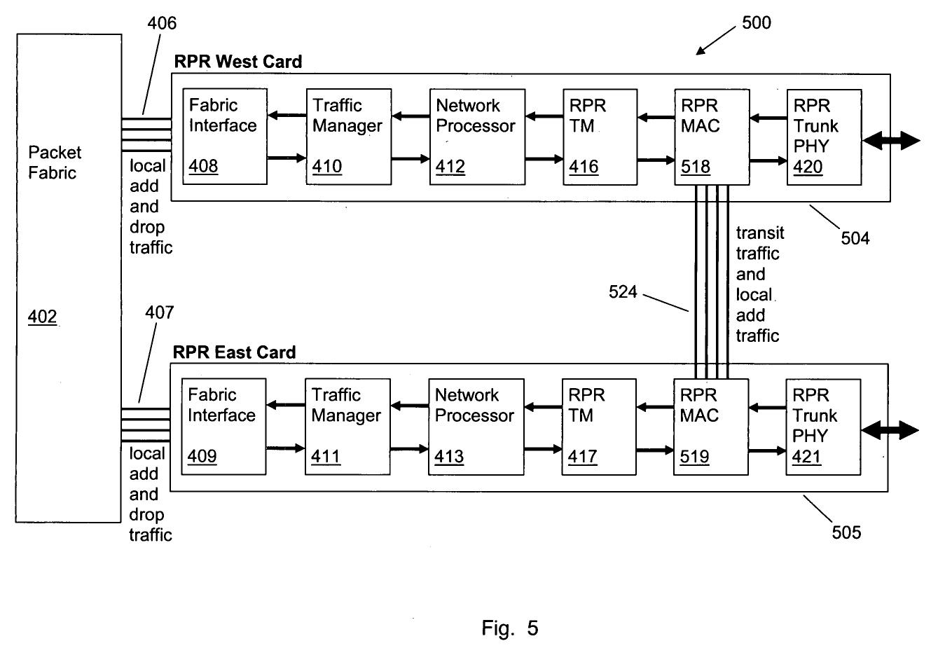

Referring to FIG. 5, an architecture in accordance with the present invention that overcomes some of the disadvantages described above (see FIG. 4 and associated text), includes sharing the interconnecting bus that is used for the transit traffic between the two RPR MACs. More particularly, this sharing includes the transit traffic and the local add traffic that needs to be re-directed to the other RPR line card. FIG. 5 is a high-level block diagram of an RPR station 500 in accordance with the present invention in which local add traffic between a West line card 504 and an East line card 505 is communicated over shared lines 524 between the RPR Half-MACs of each line card. More particularly, West line card 504 and East line card 505 are coupled to packet fabric 402. RPR West line card 504 includes a fabric interface chip 408 coupled to a TM 410; an NP 412 coupled to TM 410; RPR TM block 416 coupled to an NP 412; an RPR MAC 518 coupled to an RPR TM block 416; and an RPR trunk PHY 420 coupled to RPR MAC 518. Similarly, RPR East line card 505 includes a fabric interface chip 409 coupled to a TM 411; an NP 413 coupled to TM 411; an RPR TM block 417 coupled to NP 413; an RPR MAC 519 coupled to RPR TM block 417; and an RPR trunk PHY 421 coupled to RPR MAC 519. It can be seen that the Reroute-and-Receive blocks 414 and 415 of FIG. 4 are not included in the architecture of FIG. 5.

It is noted that any suitable communication means between the RPR Half-MACs is contemplated by the present invention. For example, in addition to the multi-lane electrical bus (i.e., shared lines 524), shown in FIG. 5, a serial electrical bus, a single-fiber optical link, a parallel optical link with multiple fibers or wavelengths, or a wireless link may be used.

It is an advantage of the architecture of FIG. 5, that the logical block referred to Reroute-and-Receive is omitted. In this way, the complexity and power consumption are reduced. In some embodiments, even the number of components, such as integrated circuits, that are required to implement a line card is reduced.

In some embodiments of the present invention the first MAC is operable to mark local add traffic packets originating at the first RPR line card and which have a requirement to be redirected to the second RPR line card; the second MAC is operable to mark local add traffic packets originating at the second RPR line card and which have a requirement to be redirected to the first RPR line card; the second MAC is operable to recognize local add packets marked by the first MAC and responsive thereto queue these packets separately from transit traffic in the second memory storage area; and the first MAC is operable to recognize local add packets marked by the second MAC and responsive thereto queue these packets separately from transit traffic in the first memory storage.

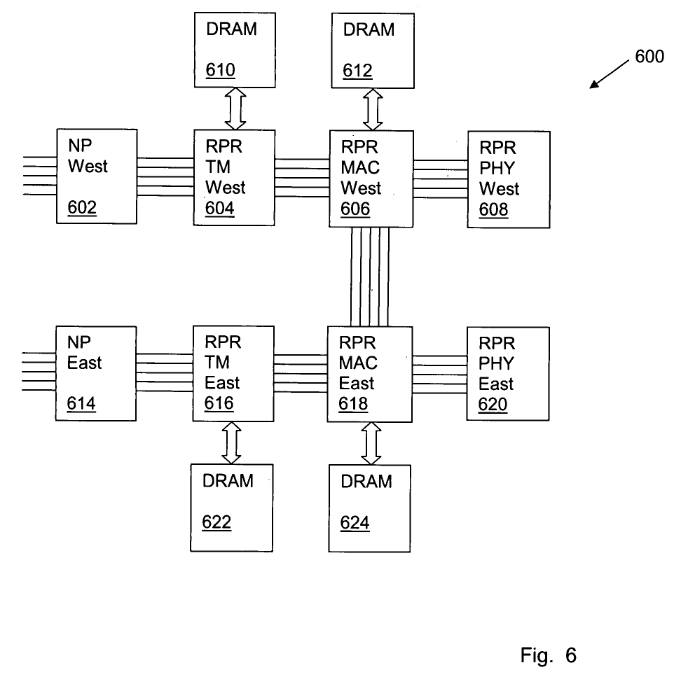

FIG. 6 is a schematic block diagram of portions of a pair of RPR (East/West) line cards, showing the data paths for exchanging add traffic between the Half-MACs of each RPR line card. More particularly, a West Network Processor 602 is coupled to the West RPR Traffic Manager 604, which is also coupled to DRAM 610 and West RPR MAC 606. West RPR MAC 606 is also coupled to DRAM 612 and West RPR (trunk) PHY 608. Similarly, East Network Processor 614 is coupled to East RPR Traffic Manager 616, which is also coupled to DRAM 622 and East RPR MAC 618. East RPR MAC 618 is further coupled to DRAM 624 and East RPR (trunk) PHY 620. A communication pathway between West RPR MAC 606 and East RPR MAC 618 is also shown. It is this communication pathway which is shared by transit traffic and by local add exchange traffic in various embodiments of the present invention.

In the illustrative embodiment of FIG. 6, West RPR Traffic Manager 604 is implemented as an integrated circuit, and may, for example, perform queuing for class A on-chip, and queuing of classes B and C off-chip in an extended memory represented by DRAM 610. Similarly, East RPR Traffic Manager 616 is implemented as an integrated circuit, and may perform queuing for class A traffic on-chip, and queuing of classes B and C off-chip in an extended memory represented by DRAM 622. It will be appreciated by those skilled in the art that although the extended memory is illustrated as DRAM, any suitable data storage medium, including but not limited to SRAM and other types of Random Access Memory, either on-chip off-chip the RPR TM, may be used. In fact, although not presently preferred, even serial access memory architectures may be used for such architectures as long as the required data can be accessed in a timely manner. It will be further appreciated by those skilled in the art that the present invention is not limited to any particular memory technology, or interface protocol.

Still referring to FIG. 6, the local add traffic coming from the packet fabric will be relayed (e.g., 802.3 [symbol] 802.17) and classified. The address and class mapping in the network processors 602 and 614, respectively, may include the ringlet (i.e., East/West) selection. The network processor 602, 614 will add a corresponding bit or label. The ringlet selection may also be performed by other logical entities that have access to the RPR topology database, for example certain state machines that belong logically to the RPR MACs 606 and 608, respectively, but might be realized as a separate block before the RPR TMs 604 and 616, respectively.

The RPR TMs 604 and 616 perform queuing (class A on-chip, for example, and class B/C off-chip with extended memory) of the incoming packets of the local add traffic flows. The queue selection for the TM is typically performed by the NP. In various embodiments of the present invention, the NP, or any other logical entity, has performed the ringlet selection and has hence added a corresponding identifier to separate the queues, i.e., local add traffic flows for ringlet 0 and 1 are queued in separate queues by the RPR TM. Accordingly, embodiments of the present invention require twice as many queues for the RPR TM.

The RPR Half-MACs 606 and 618 are configured to schedule the traffic on and off the ring. Those local add packets that will go onto the ring from the same line card and the corresponding RPR trunk PHY 608 and 620, respectively, will be scheduled as in any other RPR implementation. However, those local add packets that have to be transferred to the other RPR line card will be put onto the transit lanes interconnecting the two RPR line cards. Hence the scheduler in the MAC will release those packets from the memory of the traffic manager whenever the traffic flow of the transit allows such a release.

Depending on the class (e.g., A, B or C) of local add traffic and the RPR line card architecture, those packets will then be read from either the Primary Transit Queue (PTQ for class A) or from the Secondary Transit Queue (STQ for class B or C). This means that class B/C local add traffic will be queued twice in those circumstances where class B/C local add traffic has to be transferred to the opposite RPR line card. That is, the class B/C local add traffic will be queued once in the RPR traffic manager and once in the Secondary Transit Queue of the opposite RPR line card. This will add extra latency which is acceptable because class B and C are of lower priority.

It is noted that, for reasons related to the fairness protocol of RPR (IEEE 802.17) and other technical details it will be required for the PTQ and STQ that the local add traffic coming from the opposite RPR line card is separated from the transit traffic coming from the ring. Accordingly, various embodiments of the present invention include two separate queues in the STQ or PTQ memory.

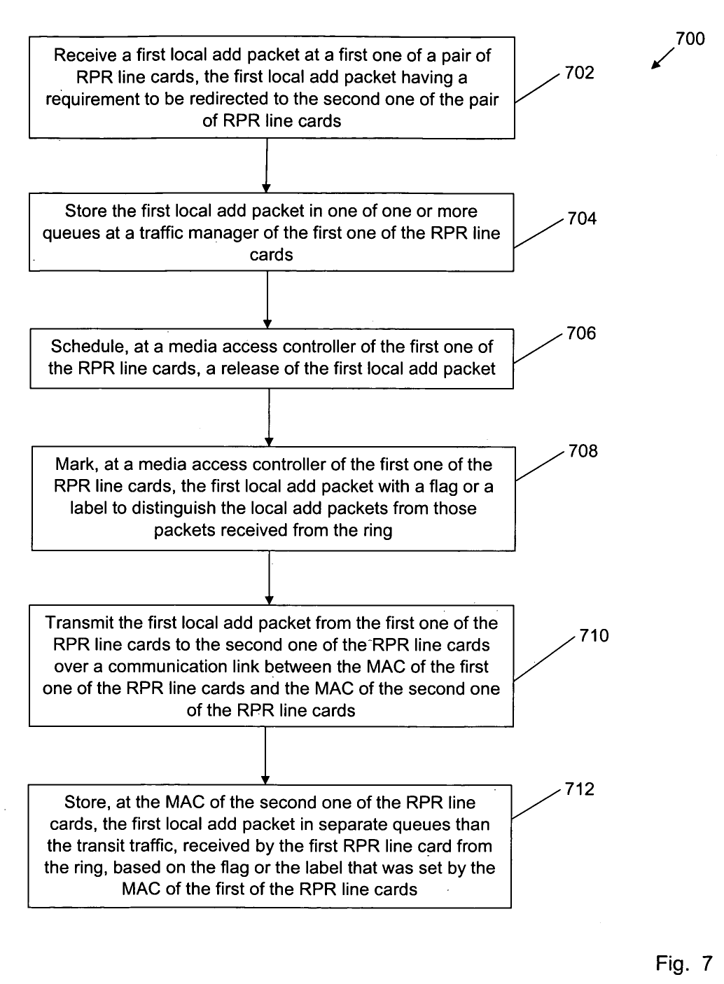

FIG. 7 illustrates a method in accordance with the present invention. More particularly, FIG. 7 illustrates a method 700 of exchanging local add traffic between a pair of Resilient Packet Ring (RPR) line cards including receiving 702 a first local add packet at a first one of the pair of RPR line cards, the first local add packet having a requirement to be redirected to the second one of the pair of RPR line cards; storing 704 the first local add packet in one of one or more queues at a traffic manager (TM) of the first one of the RPR line cards; scheduling 706, at a media access controller (MAC) of the first one of the RPR line cards, a release of the first local add packet; marking 708 at a MAC of the first one of the RPR line cards, the first local add packet with a flag or a label to distinguish the first local add packet from those packets received from the ring; transmitting 710 the first local add packet from the first one of the RPR line cards to the second one of the RPR line cards over transit lanes between the MAC of the first one of the RPR line cards and a MAC of the second one of the RPR line cards; and storing 712, at the MAC of the second one of the RPR line cards, the first local add packet in a queue separate from the queues in which the transit traffic received by the first RPR line card from the ring are stored when transferred to the second RPR line card, based on the flag or label that was set by the MAC of the first of the RPR line cards. It is noted that in this illustrative method the pair of RPR line cards are configured as an East/Nest pair of RPR line cards.

### CONCLUSION

Embodiments of the present invention provide local add traffic exchange capability between separate East/West RPR cards by sharing the transit lines between the Half-MACs on each of the two cards.

Embodiments of the present invention may be used in any RPR architecture that is based on separate East/Nest cards. This also applies to architectures where the client ports (e.g., Ethernet ports) are physically located on the RPR cards and where the local add traffic would arrive not from a packet fabric, but directly from the client PHY's.

It is to be understood that the present invention is not limited to the embodiments described above, but encompasses any and all embodiments within the scope of the subjoined Claims and their equivalents.

What is claimed is:

1. A method of exchanging local add traffic between a pair of Resilient Packet Ring (RPR) line cards, comprising:
receiving a first local add packet at a first one of the pair of RPR line cards, the first local add packet having a requirement to be redirected to the second one of the pair of RPR line cards;
storing the first local add packet in one of one or more queues at a traffic manager (TM) of the first one of the RPR line cards;
scheduling, at a media access controller (MAC) of the first one of the RPR line cards, a release of the first local add packet; and
transmitting the first local add packet from the first one of the RPR line cards to the second one of the RPR line cards over transit lanes between the MAC of the first one of the RPR line cards and a MAC of the second one of the RPR line cards;
wherein the pair of RPR line cards are configured as an East/West pair of RPR line cards.

2. The method of claim 1, further comprising determining a class associated with the first local add packet.

3. The method of claim 2, further comprising:
selecting one of the one or more queues from which to read the first local add packet;
wherein selecting is based, at least in part, on the determination of the class of the local add packet.

4. The method of claim 2, further comprising:
receiving one or more transit packets at the first one of the RPR line cards.

5. The method of claim 4, wherein scheduling comprises:
determining whether a traffic flow of transit packets allows transmitting the first local add packet from the first one of the RPR line cards to the second one of the RPR line cards.

6. The method of claim 4, further comprising transferring at least one transit packet between the pair of RPR line cards.

7. The method of claim 5, further comprising:
storing the first local add packet in one of one or more transit queues managed by the RPR MAC of the second one of the RPR line cards prior to transmitting the first local add packet onto a ring, if the class associated with the first local add packet indicates a priority less than the highest priority.

8. The method of claim 5, wherein the MAC of the first one of the RPR line cards is communicatively coupled with the MAC of the second one of the RPR line cards.

9. A Resilient Packet Ring (RPR) station, comprising:
a first RPR line card, comprising:
a first network processor coupled to a first RPR traffic manager block; and
a first media access controller (MAC) coupled to the first RPR traffic manager block; and
a first physical interface (PHY) coupled to the first MAC;
a second RPR line card, comprising:
a second network processor coupled to a second RPR traffic manager block;
a second media access controller (MAC) coupled to the second RPR traffic manager block; and
a second physical interface (PHY) coupled to the second MAC; and
a communication means disposed between the first MAC and the second MAC;
wherein the first MAC is adapted to release a first local add packet stored within a queue of the first traffic manager block, the first local add packet having a requirement to be redirected to the second RPR line card, responsive to a determination that a traffic flow of transit packets allows such a release.

10. The RPR station of claim 9, further comprising:
a first fabric interface coupled to the first network processor;
a second fabric interface coupled to the second network processor; and
a packet fabric coupled to first and second fabric interfaces.

11. The RPR station of claim 10, wherein the first RPR line card and the second RPR line card are configured as an East/West pair of RPR line cards.

12. The RPR station of claim 10, wherein the second MAC is adapted to release a second local add packet stored within a queue of the second RPR traffic manager block, the second local add packet having a requirement to be redirected to the first RPR line card, responsive to a determination that a traffic flow of transit packets allows such a release.

13. The RPR station of claim 10, wherein the first RPR traffic manager block includes one or more queues, wherein the first local add packet is characterized by a class, and wherein the first RPR traffic manager is operable to store the first local add packet in one of the one or more queues based, at least in part, on the class of the first local add packet.

14. The RPR station of claim 9, further comprising:
a first memory storage area coupled to the first MAC; and
a second memory storage area coupled to the second MAC;
wherein the second memory storage area is adapted to receive the first local add packet if the class of the first local add packet indicates a priority less than the highest priority.

15. The RPR station of claim 14, wherein the first memory storage area is adapted to receive a second local add packet originating from the second RPR line card if the class of the second local add packet indicates a priority less than the highest priority.

16. The RPR station of claim 11, wherein the first RPR line card further comprises:
a first traffic manager disposed between, and coupled to each of, the first fabric interface and the first network processor.

17. The RPR station of claim 16, wherein the second RPR line card further comprises:
a second traffic manager disposed between, and coupled to each of, the second fabric interface and the second network processor.

18. The RPR station of claim 17, wherein the second RPR line card includes at least two queues operable to store local add traffic originating at the first RPR line card and destined for the second RPR line card in a first one of the at least two queues, and further operable to store transit traffic received at the second RPR line card in a second one of the at least two queues, such that the local add traffic originating at the first RPR line card and destined for the second RPR line card and the transit traffic are separated into different queues.

19. The RPR station of claim 9, wherein the communication means comprises a means selected from the group consisting of a multi-lane electrical bus, a serial electrical bus, a single-fiber optical link, a parallel optical fiber link, and a wireless link.

20. The RPR station of claim 14, wherein the first memory storage area, managed by the first RPR MAC, is operable to store both the transit traffic originating from the ring and the local add traffic originating from the second RPR line card, and wherein the second memory storage area, managed by the second RPR MAC, is operable to store both the transit traffic originating from the ring and the local add traffic originating from the first RPR line card.

21. The RPR station of claim 14, wherein the first MAC is operable to mark local add traffic packets originating at the first RPR line card and which have a requirement to be redirected to the second RPR line card; the second MAC is operable to mark local add traffic packets originating at the second RPR line card and which have a requirement to be redirected to the first RPR line card; the second MAC is operable to recognize local add packets marked by the first MAC and responsive thereto queue these packets separately from transit traffic in the second memory storage area; and the first MAC is operable to recognize local add packets marked by the second MAC and responsive thereto queue these packets separately from transit traffic in the first memory storage area.
